(19) United States
(12) Patent Application Publication
(10) Pub. No.: US 2026/0096700 A1
(43) Pub. Date: Apr. 9, 2026

(54) TRASH RECEPTACLE WITH DEPLOYABLE TOILET STAND

(71) Applicant: Creosote Holdings, LLC, Tucson, AZ (US)

(72) Inventor: Nate Lipton, Tucson, AZ (US)

(73) Assignee: Creosote Holdings, LLC, Tucson, AZ (US)

(21) Appl. No.: 18/907,259

(22) Filed: Oct. 4, 2024

(51) Int. Cl. A47K 17/02; B65F 1/02

(52) U.S. Cl. CPC A47K 17/028; B65F 1/02

(57) ABSTRACT

An apparatus including: a housing including a receptacle; a first wing coupled to the housing at a first side of the housing; a second wing coupled to the housing at a second side of the housing opposite the first side of the housing; a first leg coupled to the first wing; and a second leg coupled to the second wing. The apparatus is configured to adjust between (i) a closed configuration in which the first and second wings are folded down to the housing and (ii) an open configuration in which the first and second wings extend away from the housing. Other embodiments are described.

### TECHNICAL FIELD

This disclosure relates generally to a trash receptacle with deployable toilet stand.

### BACKGROUND

When sitting on a toilet, some people have difficulty defecating, which can be complicated by various conditions, such as constipation and hemorrhoids, among others. A squatting position can assist with defecation. Conventional toilet stands that assist with squatting are bulky and unsightly. Most toilet areas have a trash can near them. Having both a trash can and a toilet stand in a small area can take up valuable square footage.

### BRIEF DESCRIPTION OF THE DRAWINGS

To facilitate further description of the embodiments, the following drawings are provided in which:

FIG. 1 illustrates a front, top, right view of a trash receptacle with deployable toilet stand in an open configuration, according to an embodiment;

FIG. 2 illustrates a bottom view of trash receptacle with deployable toilet stand in the open configuration;

FIG. 3 illustrates a front, top, right view of trash receptacle with deployable toilet stand in a closed configuration;

FIG. 4 illustrates a bottom, rear view of trash receptacle with deployable toilet stand in the closed configuration;

FIG. 5 illustrates a front, top, left view of trash receptacle with deployable toilet stand in the open configuration in front of a toilet and being used as a footrest; and

FIG. 6 illustrates a front, top view of trash receptacle with deployable toilet stand in a closed configuration in a restroom, next to a wall, being utilized as a trash bin.

For simplicity and clarity of illustration, the drawings and figures herein illustrate the general manner of the systems, methods, and construction, and descriptions and details of well-known features and techniques may be omitted to avoid unnecessarily obscuring the invention. Additionally, elements in the drawings and figures are not necessarily drawn to scale. For example, the dimensions of some of the elements, steps, and features in the figures may be exaggerated relative to other elements, steps, and features, to help improve understanding of embodiments of the present invention. The same reference numerals in different figures denote the same elements.

The terms “first,” “second,” “third,” “fourth,” and the like in the description and in the claims, if any, are used for distinguishing between similar elements and features and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value. When “approximately” describes an angle or orientation, in some embodiments, “approximately” can mean within five degrees of the stated angle or orientation. In other embodiments, “approximately” can mean within ten degrees of the stated angle or orientation. In further embodiments, “approximately” can mean within twenty degrees of the stated angle or orientation.

### DESCRIPTION OF EXAMPLES OF EMBODIMENTS

Various embodiments include an apparatus including: a housing including a receptacle; a first wing coupled to the housing at a first side of the housing; a second wing coupled to the housing at a second side of the housing opposite the first side of the housing; a first leg coupled to the first wing; and a second leg coupled to the second wing. The apparatus is configured to adjust between (i) a closed configuration in which the first and second wings are folded down to the housing and (ii) an open configuration in which the first and second wings extend away from the housing. As metropolitan areas are becoming more densely populated with expensive and small living spaces, this inconspicuous two-in-one device can help save square footage and is more aesthetically pleasing than having a separate trash can and toilet stool.

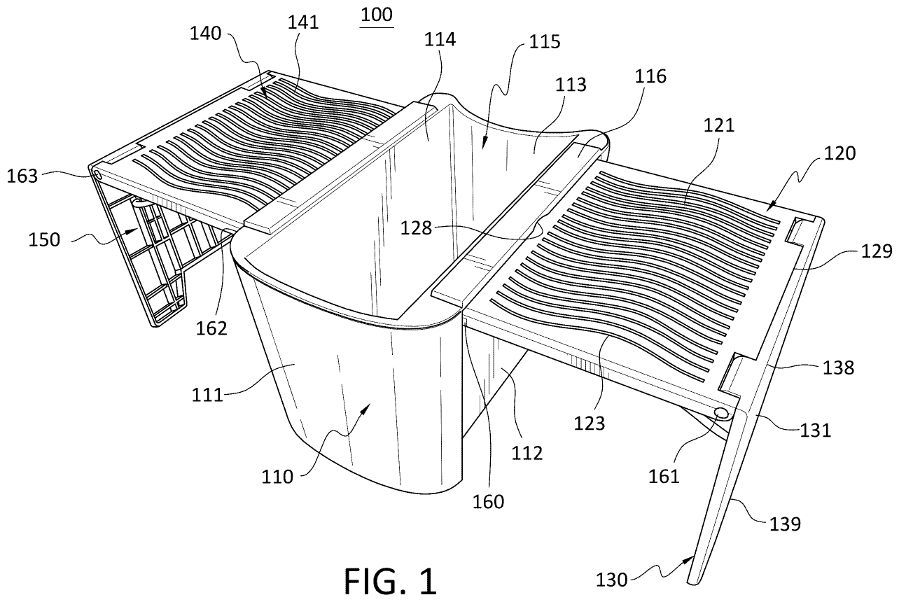

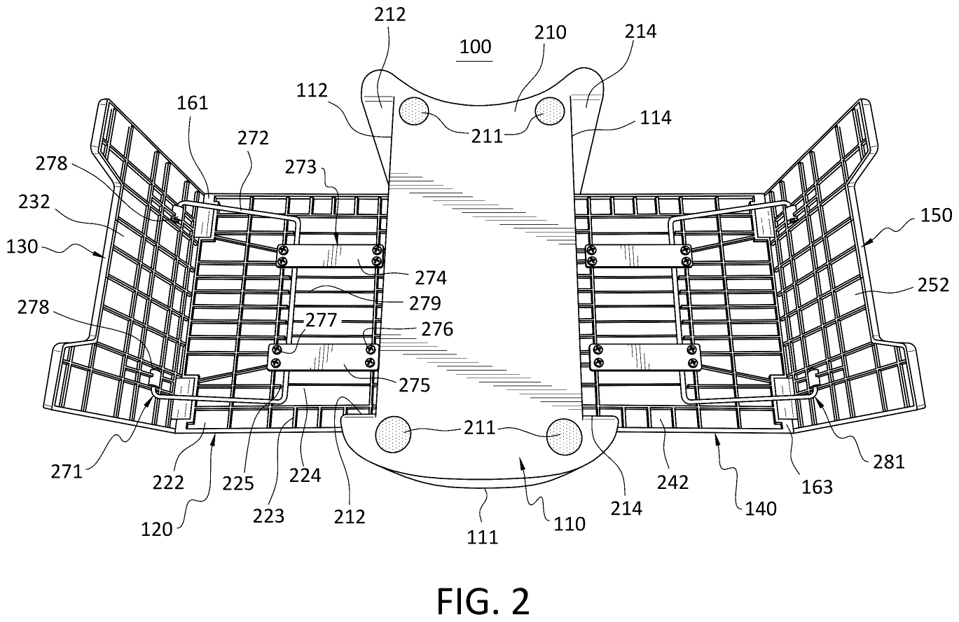

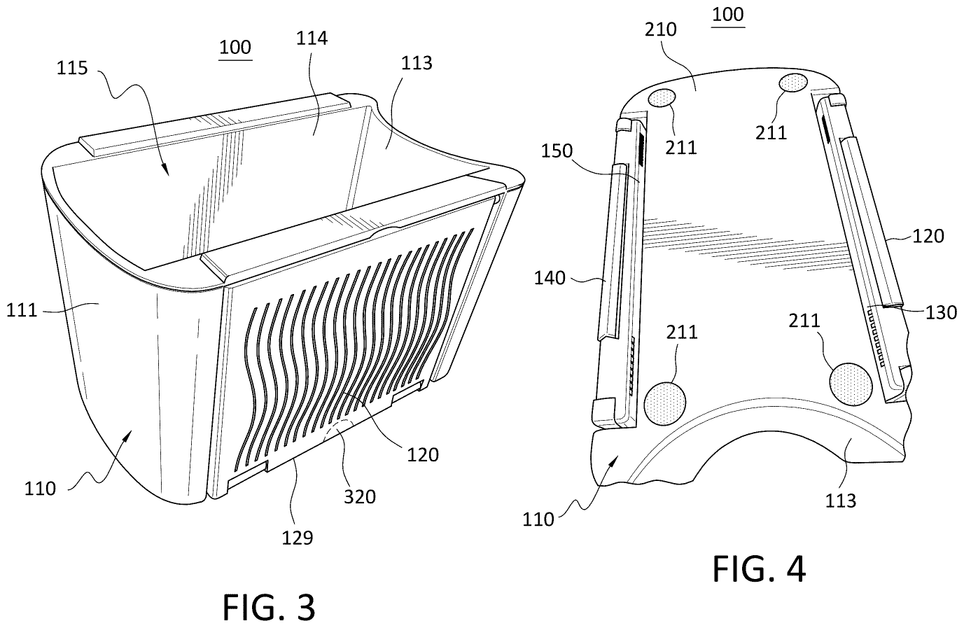

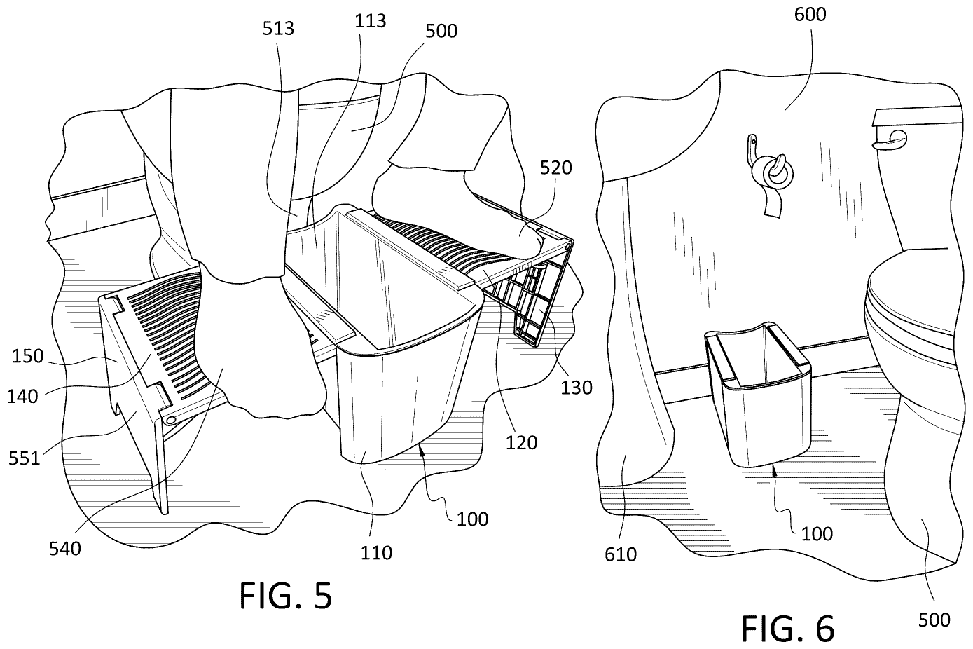

FIG. 1 illustrates a front, top, right view of a trash receptacle with deployable toilet stand 100 in an open configuration, according to an embodiment. FIG. 2 illustrates a bottom view of trash receptacle with deployable toilet stand 100 in the open configuration. FIG. 3 illustrates a front, top, right view of trash receptacle with deployable toilet stand 100 in a closed configuration. FIG. 4 illustrates a bottom, rear view of trash receptacle with deployable toilet stand 100 in the closed configuration. FIG. 5 illustrates a front, top, left view of trash receptacle with deployable toilet stand 100 in the open configuration in front of a toilet 500 and being used as a footrest. FIG. 6 illustrates a front, top view of trash receptacle with deployable toilet stand 100 in a closed configuration in a restroom, next to a wall 600, being utilized as a trash bin. Trash receptacle with deployable toilet stand 100 is merely exemplary, and embodiments of the trash receptacle with deployable toilet stand are not limited to the embodiments presented herein. The trash receptacle with deployable toilet stand can include many different embodiments or examples not specifically depicted or described herein.

In many embodiments, trash receptacle with deployable toilet stand 100 can include a housing 110, which can include various sidewalls, such as sidewalls 111-114. In many embodiments, housing 110 can include a receptacle 115, which can be a cavity defined above a base 210 of housing 110 and within sidewalls 111-114 of housing 110. In many embodiments, receptacle 115 can be a trash receptacle, which can be configured to hold trash, garbage, refuse, and/or other items. In many embodiments, a bag (not shown) can be used within receptacle 115. For example, a top opening of the bag can extend around a top 116 of housing 110 while the bag sits within receptacle 115. In some embodiments, one or more sidewalls 111-114 can be substantially flat, and/or one or more of sidewalls can be curved. For example, sidewall 113 can be curved inward into receptacle 115 such that an exterior surface of sidewall 113 curves concavely to conform at least partially to the convex curve of a front base surface 513 of a toilet 500, such as shown in FIG. 5. In other embodiments, sidewall 113 can be substantially flat. In some embodiments, base 210 of housing 110 can include surface contacts 211, which can be rubber, silicone, neoprene, urethane, cork, or another material that is non-slip, slip-resistant, or facilitates non-scratch contact with a floor surface. In some embodiments, trash receptacle with deployable toilet stand 100 and/or housing 110 can include a lid (not shown) that can cover a top of receptacle 115.

In some embodiments, trash receptacle with deployable toilet stand 100 can include wings 120 and 140, and legs 130 and 150. Wing 120 can be coupled to housing 110 at a first side of housing 110, such as at sidewall 112, and in many embodiments can be coupled to the first side of housing 110 proximate to top 116 of housing 110. For example, a proximal end 128 of wing 120 can be coupled to housing 110 using a hinge 160. Wing 120 can include a first side 121 and a second side 222 opposite first side 121. Leg 130 can be coupled to wing 120. For example, a proximal end 138 of leg 130 can be coupled to a distal end 129 of wing 120 (opposite proximal end 128) at a hinge 161. A distal end 139 of leg 130 can be configured to be placed on a floor surface when base 220 of trash receptacle with deployable toilet stand 100 is placed on the floor surface in the open configuration. Leg 130 can include a first side 131 and a second side 232 opposite first side 131. In many embodiments, second side 222 of wing 120 and/or second side 232 of leg 130 can include ribs or other structural supports, such as ribs 223 on second side 222.

Wing 140 can be similar to wing 120, and various components of wing 140 can be similar or identical to wing 120. Leg 150 can be similar to leg 130, and various components of leg 150 can be similar or identical to leg 130. For example, wing 140 can be coupled to housing 110 at a second side of housing 110, such as at sidewall 114, and in many embodiments can be coupled to the second side of housing 110 proximate to top 116 of housing 110. For example, a proximal end of wing 140 can be coupled to housing 110 using a hinge 162. Wing 140 can include a first side 141 and a second side 242 opposite first side 141. Leg 150 can be coupled to wing 140. For example, a proximal end of leg 150 can be coupled to a distal end of wing 140 (opposite the proximal end of wing 140) at a hinge 163. A distal end of leg 150 can be configured to be placed on a floor surface when base 220 of trash receptacle with deployable toilet stand 100 is placed on the floor surface in the open configuration. Leg 150 can include a first side 551 and a second side 252 opposite first side 551. In many embodiments, second side 242 of wing 140 and/or second side 252 of leg 150 can include ribs or other structural supports.

In some embodiments, the wings (e.g., 120, 140) can be supported in the open configuration with structural supports other than legs, such as locking hinges, or other suitable supports. In other embodiments, instead of being hinged, the wings can be detachable from one or more sides in the closed configuration and inserted in place in the open configuration. In various embodiments, a trash bin that appears has merely a trash bin can be converted to a toilet stand, similar to toilet stand 100.

When trash receptacle with deployable toilet stand 100 is deployed in the open configuration, such as shown in FIGS. 1-2 & 5, first side 121 of wing 120 and first side 141 of wing 140 can be footrest surfaces for feet of a person (e.g., feet 520 and 540, respectively) to facilitate the person using the toilet (e.g., 500) in a squatting position. In some embodiments first sides 121 and 141 can include a slip-resistant pattern 123, such as the wavy recessed pattern of pattern 123, or another suitable pattern, such as recesses, protrusions, etc., which can prevent or decrease slipping of feet (e.g., 520, 540) on first sides 121 and 141. In the open configuration, wing 120 can extend away from housing 110, such that, although proximal end 128 is coupled to housing 110, distal end 129 is positioned away from housing 110. A distal end of wing 140 can similarly extend away from housing 110 in the open configuration.

In the open configuration, leg 130 can hold up and support up wing 120, and leg 150 can hold up and support wing 140. For example, wings 120 and 140 can be held up in the open configuration in an approximately horizontal position when base 220 is on an approximately horizontal floor surface, and/or wings 120 and 140 can be approximately parallel to base 220. In the open configuration, leg 130 can extend downward from proximal end 138 to distal end 139, and in many embodiments in the open configuration, distal end 139 of leg 130 can extend somewhat outward from housing 110. For example, in the open configuration, distal end 139 can be further from housing 110 than proximal end 138 is from housing 110, which can prevent leg 130 from folding inward toward housing 110 when being using as a footrest. The distal end of leg 150 can similarly extend somewhat outward from housing 110 in the open configuration.

In the closed configuration, such as shown in FIGS. 3-4 & 6, wings 120 and 140 are folded in proximate to housing 110, and in many embodiments, leg 130 is folded between wing 120 and housing 110, and leg 150 is folded between wing 140 and housing 110. For example, to adjust trash receptacle with deployable toilet stand 100 from the open configuration to the closed configuration, leg 130 can be folded inward such that distal end 139 of leg 130 is proximate to proximal end 128 of wing 120, and/or such that second side 232 of leg 130 is against or proximate to second side 222 of wing 120. With leg 130 folded inward, wing 120 can be folded downward, such that distal end 129 of wing 120, proximal end of leg 130, and hinge 161 are proximate to sidewall 112 and base 220 of housing 110, and/or such that first side 131 of leg 130 is against or proximate to sidewall 112. In the closed configuration, first side 121 of wing 120 can form an outer sidewall of trash receptacle with deployable toilet stand 100, as sidewall 112 can be covered (fully or at least partially) by leg 130, which together can be covered (fully or at least partially) by wing 120. Leg 150 and wing 140 can be folded in similarly as described for leg 130 and wing 120.

In many embodiments, housing 110 can include recess walls 214 and 212 so that when in the closed configuration, wings 120 and 140, respectively, are approximately flush with the exterior of housing 110. For example, sidewall 112 can be set inward and recessed from an outermost exterior side of housing 110 using recess wall 212, and sidewall 114 can be set inward and recessed from an outermost exterior side of housing 110 using recess wall 214. In the closed configuration, trash receptacle with deployable toilet stand 100 can appear to be nothing more than a conventional trash bin, as the deployable stand pieces (e.g., legs 130 and 150, and wings 120 and 140) are folded in and inconspicuous, as shown in FIG. 6 In many embodiments, trash receptacle with deployable toilet stand 100 can be placed against a wall 600 in a restroom, such as next to a sink 610, and used as a trash bin, as shown in FIG. 6.

When desired to be used as a toilet stand, trash receptacle with deployable toilet stand 100 can be moved next to toilet 500 and adjusted to the open configuration, as shown in FIG. 5. To adjust trash receptacle with deployable toilet stand 100 from the closed configuration to the open configuration, wing 120 can be folded out away from housing 110, leg 130 can be folded down away from wing 120, wing 140 can be folded out away from housing 110, and leg 150 can be folded down away from wing 140, to the open configuration as shown in FIG. 5. In some embodiments, wing 120 can include an opening 320, such as at distal end 129, which can be a cut-out, aperture, or other opening that facilitates opening wing 120. In some embodiment, wing 140 can have a similar opening (not shown).

In some embodiments, trash receptacle with deployable toilet stand 100 can include hinge restraints (e.g., 271, 281). For example, hinge restraint 271 can be coupled to wing 120 and leg 130, and hinge restraint 281 ca be coupled to wing 140 and leg 130. The hinge restraints (e.g., 271, 281) can prevent the associated hinge (e.g., 161, 163, respectively) from opening too far. For example, hinge restraint 271 can include a wire 272 that is coupled in wire end couplings 278 on second side 232 of leg 130. The wire extends around through a slide restrictor 273, which is formed by braces 274-275 coupled to wing 120. For example, brace 275 can be coupled to wing 120 by screws at proximal end 276 and distal end 277. A slide region 224 can be formed along which wire 272 can slide between second side 222 and the braces (e.g., 274, 275). In many embodiments, the ribs (e.g., 223) on second side 222 can be removed or smaller in this region to allow space for wire 272 to slide. In some embodiments, an edge 225 of ribs 223 can prevent wire 272 from sliding further distal beyond edge 225, which can prevent leg 130 from extending too far around hinge 161, so that leg 130 can support wing 120 in the open configuration. To adjust trash receptacle with deployable toilet stand 100 from the open configuration to the closed configuration, wire 272 can be slid within slide region 224 from distal end 277 to proximal end 276, as leg 130 is folded toward wing 120. When opened from the closed configuration to the open configuration, in some embodiments, trash receptacle with deployable toilet stand 100 can include one or more nubs 279 on second side 222 of wing 120, which can allow wire 272 to pass over nubs 279 and snap into position in the open configuration, to indicate that leg 130 is an the open configuration. Hinge restraint 281 can be similar on wing 140 and leg 150 as described for hinge restraint 271 on wing 120 and leg 130.

As shown in FIGS. 3-4 & 6, in the closed configuration, trash receptacle with deployable toilet stand 100 appears to be a normal trash bin, and can be used as such. Unlike conventional toilet stands, it is not bulky or unsightly. As shown in FIGS. 1-2 & 5, trash receptacle with deployable toilet stand 100 can be readily deployed from the closed configuration to the open configuration, and used as a toilet stand. In various embodiments, trash receptacle with deployable toilet stand 100 can be made out of a lightweight material, such as ABS (Acrylonitrile Butadiene Styrene), PP (polypropylene),

Although the trash receptacle with deployable toilet stand 100 has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus comprising:
a housing comprising a receptacle;
a first wing coupled to the housing at a first side of the housing; and
a second wing coupled to the housing at a second side of the housing opposite the first side of the housing,
wherein:
the apparatus is configured to adjust between (i) a closed configuration in which the first and second wings are folded down to the housing and (ii) an open configuration in which the first and second wings extend away from the housing.

2. The apparatus of claim 1 further comprising:
a first leg coupled to the first wing; and
a second leg coupled to the second wing.

3. The apparatus of claim 2, wherein, in the closed configuration:
the first leg is folded between the first wing and the first side of the housing; and
the second leg is folded between the second wing and the second side of the housing.

4. The apparatus of claim 2, wherein, in the open configuration:
the first leg holds up the first wing; and
the second leg holds up the second wing.

5. The apparatus of claim 2, wherein:
the first wing is hingedly coupled to the first side of the housing at a proximal end of the first wing;
the first leg is hingedly coupled to the first wing at a distal end of the first wing;
the second wing is hingedly coupled to the second side of the housing at a proximal end of the second wing; and
the second leg is hingedly coupled to the second wing at a distal end of the second wing.

6. The apparatus of claim 2 further comprising:
a first hinge restraint coupled to the first wing and the first leg;
a second hinge restraint coupled to the second wing and the second leg;
the first hinge restraint comprises a first wire and first slide restrictor; and
the second hinge restraint comprises a second wire and second slide restrictor.

7. The apparatus of claim 1, wherein:
the first wing comprises a first opening configured to facilitate opening the first wing from the closed configuration; and
the second wing comprises a second opening configured to facilitate opening the second wing from the closed configuration.

8. The apparatus of claim 1, wherein, in the open configuration, the first wing and the second wing are approximately parallel to a base of the housing.

9. The apparatus of claim 1 further comprising:
a first leg coupled to the first wing; and
a second leg coupled to the second wing,
wherein:
in the closed configuration, the first leg is folded between the first wing and the first side of the housing, and the second leg is folded between the second wing and the second side of the housing;
in the open configuration, the first leg holds up the first wing, the second leg holds up the second wing, and the first wing and the second wing are approximately parallel to a base of the housing;
the first wing is hingedly coupled to the first side of the housing at a proximal end of the first wing;
the first leg is hingedly coupled to the first wing at a distal end of the first wing;
the second wing is hingedly coupled to the second side of the housing at a proximal end of the second wing; and
the second leg is hingedly coupled to the second wing at a distal end of the second wing.
